(19) United States
(12) Patent Application Publication
(10) Pub. No.: US 2017/0028673 A1
(43) Pub. Date: Feb. 2, 2017

(54) COMPOSITE STRUCTURE

(71) Applicant: Hexcel Composites Limited, Duxford (GB)

(72) Inventor: David Tilbrook, Duxford (GB)

(73) Assignee: Hexcel Composites Limited, Cambridgeshire (GB)

(21) Appl. No.: 15/100,301

(22) PCT Filed: Dec. 18, 2014
(86) PCT No.: PCT/EP2014/078456

§ 371 Date: May 28, 2016

(30) Foreign Application Priority Data
Dec. 20, 2013 (GB) 1322767.3

(51) Int. Cl. B32B 5/12; B64D 45/02; B32B 5/22; H01B 1/24; H01B 3/00

(52) U.S. Cl. CPC B32B 5/12; H01B 1/24; H01B 3/004; B32B 5/22; B64D 45/02; B32B 2262/106; B32B 2307/202; B64C 2001/0072

(57) ABSTRACT

A composite structure (10) comprising one or more electrically conductive pathways (12) and one or more isolators for isolating the pathways (12) from the bulk of the structure (10).

### INTRODUCTION

The present invention relates to a composite structure and a method for providing electrically conductive pathways in the composite, particularly but not exclusively for airframe structures.

### BACKGROUND

Aircraft are vulnerable to lightning strike. Commercial aircraft, for example, are typically struck once or twice a year. Unlike their metal counterparts, composite structures in aircraft do not readily conduct away the extreme electrical currents and electromagnetic forces generated by lightning strikes. Composite materials are either not conductive at all (e.g., fiberglass) or are significantly less conductive than metals (e.g., carbon fiber), so current from a lightning strike seeks the metal paths available. For that reason, lightning strike protection (LSP) has been a significant concern since the first composites were used on aircraft more than 30 years ago.

If a lightning bolt strikes an unprotected structure, up to 200,000 A of electric current seeks the path of least resistance. In the process, it may vaporize metal control cables, weld hinges on control surfaces and explode fuel vapors within fuel tanks if current arcs through gaps around fasteners and also between areas of exposed edges which are at different electrical potentials (known as edge glow). These direct effects also typically include vaporization of resin in the immediate strike area, with possible burn-through of the laminate. Other potentially hazardous direct effects of a strike can include, ejection of hot gases or hot particles into the body of an aircraft structure and sparking. Indirect effects occur when magnetic fields and electrical potential differences in the structure induce transient voltages, which can damage and even destroy onboard electronics that have not been EMF (electromagnetic field) shielded or lightning protected. The need for protection of composite structures has prompted development of a number of specialized LSP materials.

Conventional LSP strategies have three goals: provide adequate conductive paths so that lightning current remains on the structure's exterior; eliminate gaps in this conductive path to prevent arcing at attachment points and ignition of fuel vapors; and protect wiring, cables and sensitive equipment from damaging surges or transients through careful grounding, EMF shielding and application of surge suppression devices where necessary.

Traditionally, conductive paths in composite structures have been established in one of the following ways: (1) bonding metal foil to the structure as the outside ply; (2) bonding aluminium or copper mesh to the structure either as the outside ply or embedded one ply down; or (3) incorporating strands of conductive material into the laminate. All require connecting the conductive pathways to the rest of the aircraft in order to give the current an ample number of routes to safely exit the aircraft. This is typically achieved by using metal bonding strips (i.e., electrical bonding) to connect the conductive surface layer to an internal “ground plane,” which includes metal components such as engines, conduit, etc. Because lightning strikes can attach to metal fasteners in composite structures, it may be desirable to prevent arcing or sparking between them by encapsulating fastener nuts or sleeves with plastic caps or polysulfide coatings.

For external surface protection, a number of metal and metallized fiber products have been developed, typically woven and nonwoven screens and expanded foils. These mesh-like products enable the lightning's current to quickly transmit across the structure's surface, reducing its focus. Aluminum wire was one of the first LSP materials, interwoven with carbon fiber as part of the laminate. However, using aluminum with carbon fiber risked galvanic corrosion. Copper wires relieve the threat of galvanic corrosion but are three times as heavy as aluminum. As fiberglass composites gained usage in aircraft, the industry investigated foils and then expanded foils, which can be cocured with the laminate's exterior ply. Coated fibers (nickel or copper electrodeposited onto carbon and other fibers) also are used but perform much better in EMF shielding applications than as direct lightning strike protection.

Astrostrike aluminum mesh is produced by Astroseal Products (Chester, Conn.) from a solid foil, which is then perforated and expanded to increase formability and augment adhesion to composite structures.

A number of suppliers provide expanded foils, which do not require a more costly weaving process to produce and reportedly offer greater drapability and conformability than wovens. Dexmet (Naugatuck, Conn.) supplies a large variety of conductive metal products for aircraft, including aluminum, copper, phosphorous bronze, titanium and other materials.

Strikegrid is a phosphoric acid-anodized continuous expanded aluminum foil (CEAF) product supplied by Alcore (Edgewood, Md.), part of the M.C. Gill Corp. group of companies. It claims superior corrosion resistance and environmental longevity due to a proprietary coating. It is supplied on continuous rolls in 24 inch to 36 inch (610 mm to 914 mm) widths and in 2-mil and 4-mil thicknesses.

Aluminum LSP mesh is also supplied by ECC GmbH & Co. KG (formerly C. Cramer & Co., Heek-Nienborg, Germany).

Among the more recent developments are “all-in-one” LSP prepregs, which contain pre-embedded woven or nonwoven metal meshes. Applied first-down in layups, the products significantly reduce kitting and manufacturing costs, according to their suppliers.

Strike Guard LSP prepreg is manufactured by APCM (Plainfield, Conn.), and sold through and supported by partner/distributor Advanced Materials and Equipment (Barkhamsted, Conn.). APCM's LSP prepregs are made from either woven or nonwoven metal mesh impregnated with hot-melt adhesive resins that are modified with additives to enhance conductivity of the matrix, making the entire prepreg a conductive system. Metal mesh options include copper, aluminum, phosphor bronze and nickel/copper-coated polyester fiber in various sizes, ranging in weight from 0.08 lb/ft2 to 0.060 lb/ft2. Prepregs also are available with a lightweight nonwoven fiberglass veil that enhances surface finish, reducing porosity and secondary finishing required prior to painting.

Henkel Corp.'s (Bay Point, Calif.) LSP surfacing film combines its SynSkin composite surfacing film and Hysol film adhesives with Astroseal's lightweight conductive Astrostrike screens to provide a family of lightning strike surfacing layers. The screens also reduce the cost of surface preparation for painting, lower raw material part numbers and kitting time, and can be cocured with prepregs. SynSkin's unique combination of filler materials and resin matrix reportedly makes it nearly impossible to sand through once cured, offering dramatically better protection of the conductive screen during sand-and-fill operations than all-epoxy film adhesives.

Cytec Engineered Materials (Tempe, Ariz.) also produces LSP products in the form of SURFACE MASTER 905 composite surfacing film.

LSP products provide sufficient protection only when adequately incorporated into an aircraft's overall protective system. When the composite wings, fuselage skins and horizontal stabilizers are layed up, a copper tang (a thin or pointed projection that serves as an attachment point) is placed as a conductive hard point within the laminate, contacting not only the embedded copper mesh but also the bonding straps that bridge the gap between fuselage and wing.

For its composites-intensive midsize 787 commercial passenger jet, The Boeing Co. (Seattle, Wash.) has developed a multilayered approach to its lightning strike protection strategy. Boeing uses a thin metal mesh or foil in the outer layers of the composite fuselage and wings to quickly dissipate and route charge overboard and shield onboard electronics. To avoid slight gaps between wing-skin fasteners and their holes, which could enable sparking, Boeing installs each fastener precisely and then seal it on the inside. Boeing uses non-conductive filler or glass fiber to seal edges where wing skins meet internal spars in order to prevent gaps, which could permit electrons to spray out during a lightning strike, a phenomenon referred to as “edge glow.” In the fuel tanks, Boeing eliminates the threat of exploding fuel vapors by installing a nitrogen-generating system (NGS) that minimizes flammable vapors in wing tanks by filling the space with inert nitrogen gas.

Conventionally the focus in LSP has been to increase the electrical conductivity of the composite structure. However, it is also important to protect critical parts of the aircraft.

The present invention aims to obviate and/or mitigate the above described problems and/or to provide improvements generally.

### SUMMARY OF THE INVENTION

According to the invention there is provided a composite structure and a method as defined in any one of the accompanying claims.

When fibre reinforced parts containing conductive fibres such as carbon fibers are assembled into composite structures with metallic fasteners, there is potential for lightning strike discharges directly onto any fastener exposed to the outside of the aircraft. Conductive fibres which are directly in contact with a struck fastener can therefore experience a very rapid increase in electrical charge. This can in some instances result in the development of very strong electrical fields and potentials at any exposed fibre ends present on internal surfaces of the structure. If the field is high enough to exceed the dielectric breakdown threshold of the atmosphere inside the structure, dielectric breakdown can occur allowing electrical discharge to another part of the surface at lower potential. This phenomenon is called ‘edge-glow’

When the fibre reinforced structure is a wing and the internal surface comprises part of an aircraft fuel tank, edge glow can potentially result in a fuel tank ignition which is a threat to the safety of an aircraft. For this reason there are stringent requirements for the management of this phenomenon.

According to the present invention there is provided a composite structure comprising one or more electrically conductive pathways and one or more isolators for isolating the pathways from the bulk of the structure.

The pathways enable the protection of composite aircraft structures from electrical discharge phenomena such as edge glow by conducting the electricity away from critical parts. In addition the pathways enable control of the direction of electrical conductivity.

In an embodiment, the structure comprises fibre reinforcement and a reinforcement resin matrix, said pathways being formed from said fibre reinforcement and said reinforcement resin matrix. Preferably, the pathways are formed from the same fibre reinforcement and the same resin matrix as the fibre reinforcement and matrix of the bulk of the structure.

One problem of the invention is solved by introducing a one or more discontinuities into the fibres which connect a metal element of the composite structure which may be susceptible to lightning strike. This protects any internal surface from edge glow.

In another embodiment of the invention, the pathways are discrete. The isolators may comprise discontinuities in the fibre reinforcement. The fibre discontinuities may be introduced in specific locations of a ply during the laminate layup process to form the composite structure. This is done in such as way so as to ensure that the distance between discontinuities is longer than the critical fibre length for the resin/fibre combination to avoid compromising mechanical properties.

The critical fiber length (L_{c}) is defined as

$${L}_{c} = \frac{{σ}_{f}^{*} d}{2 {τ}_{c}}$$

wherein σ_{f*} is the fiber ultimate tensile strength [Pa], d is the fiber diameter [m] and τ_{c} is either the matrix/fiber bond strength or the matrix shear yield strength (whichever is smaller) [Pa].

One dimension of the isolator which extends in the direction of the fibers may correspond to n×critical fibre length wherein n=1 to 100, preferably n=1 to 50, more preferably n=1 to 10.

In a further embodiment of the invention, the isolators are formed by an isolator resin matrix.

In another embodiment of the invention, there is provided a method of controlling current paths in a composite structure comprising providing one or more electrically conductive pathways in the structure and isolating the pathways from the bulk of the structure.

The pathways are isolated from the structure by means of isolators.

In a preferred embodiment, the composite structure is prepared from a lay-up of resin preimpregnated fibrous reinforcement material layers (or prepreg layers). The layers or plies are arranged to connect metallic elements directly to the internal surface of structure. One or more cuts may be introduced in one or more plies to ensure that the pathway is isolated. The structure is then cured which results in the cut discontinuities or isolators being filled with resin.

The cut or discontinuity may be introduced in any conceivable way including slitting with a blade, laser cutting, stretching, ultrasonic disruption of the fibres. It may also be introduced automatically with attachments to robotic equipment such as ATL, AFP or other systems, or even by a manual operation.

During cure the resin from the composite flows into the cut and cures thereby forming a resilient insulative barrier to charge being conducted from the metallic element to the surface. This protects against edge glow. Several fibre discontinuites can be introduced per layer to either increase the efficacy of protection or to ensure that a safe zone is created which will accommodate tolerances in the position of the discontinuities relative to the protected surface introduced through tolerances in manufacturing due to trimming and drilling operations

Finally the composite structure may comprise other equipment for sensing or structural health monitoring.

### SPECIFIC DESCRIPTION

Specific embodiments of the invention will now be described by way of Example only and with reference to the accompanying drawings in which:

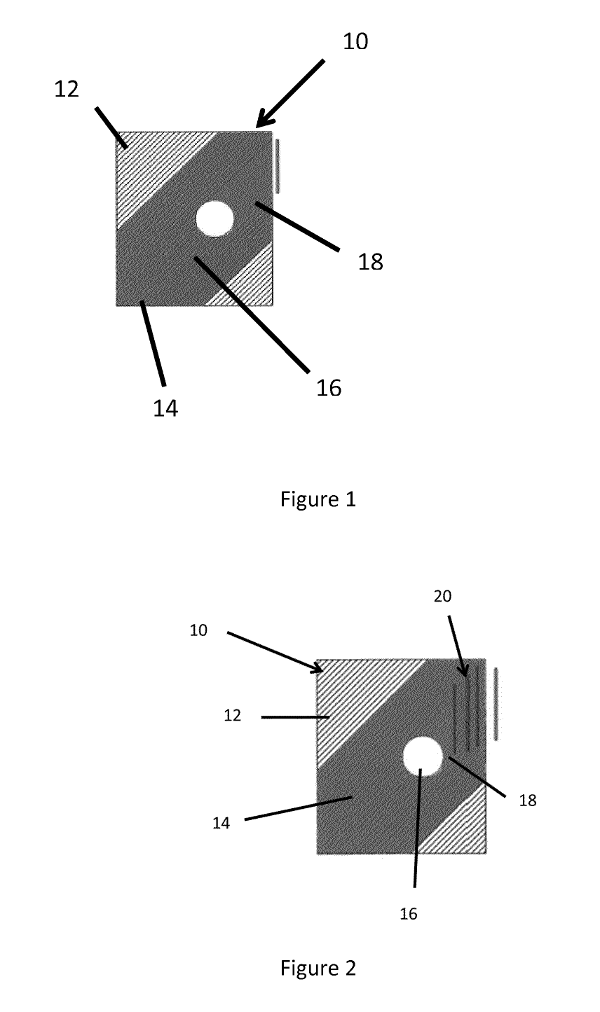

FIG. 1 presents a diagrammatic plan view of a structure not according to an embodiment of the invention; and

FIG. 2 presents a diagrammatic plan view of another structure according to an embodiment of the invention.

The present invention provides a composite structure comprising pathways for connecting connecting metallic elements to one another. The pathways are isolated from the bulk of the composite structure by means of isolators. These isolators are preferably formed by the reinforcement resin of the structure.

In aircraft, pathways may preferably be provided between mechanical fasteners and/or framing and/or LSP surface structures and/or engines and/or other metallic elements such as bond straps.

The pathways may be formed from conductive reinforcement fibers such as carbon fiber.

Alternatively, metallized fabrics and/or metallized fibers may be used. Examples of such fibers and/or fabrics will now be briefly disclosed. Diamond Fiber Composites (Cincinnati, Ohio) coats carbon fibers with a wide variety of metals including nickel, copper, silver, gold, palladium, platinum and metal hybrids (multilayer coatings) using a chemically based coating process that provides a uniform coating. These coated fibers may be obtained as continuous fiber lengths, chopped fibers, woven fabrics and nonwoven veils/mats.

Electro Fiber Technologies (Stratford, Conn.) offers single or dual metal hybrids coated onto carbon, graphite, glass, polyester and other synthetic fibers. The company supplies chopped fibers (down to 1 mm/0.04 inch in length) and continuous tows from 3K to 80K as well as nonwoven veils and mats.

Technical Fibre Products (Newburgh, N.Y.) supplies electrically conductive nonwoven mats and veils using carbon, nickel-coated carbon, aluminized glass, silicon carbide, stainless steel and nickel fibers.

Textile Products Inc. (Anaheim, Calif.) supplies a Style #4607 216 g/m2 carbon/aluminum hybrid fabric made with A54-3K carbon fiber and aluminum wire. It also supplies a Style #4608 218 g/m2 hybrid with T650/35-3K carbon fiber and aluminum wire. Both are plain weaves, 14 mils thick and 107 cm/42 inches wide.

Varinit (Greenville, S.C.) supplies electrically conductive reinforcing fabrics, developing and manufacturing products to meet customer specifications.

An embodiment of the invention is illustrated with respect to FIGS. 1 and 2. FIG. 1 shows a composite structure 10 which consists of a lay-up of multiple unidirectional carbon fiber reinforcement layers 12,14,18 which are impregnated with a resin matrix to form prepregs. The prepreg layers consist of prepreg without a conducting surface material 12, prepreg with a conducting surface material in the form of an expanded copper foil (ECF) 14 and a prepreg with a continuous conducting layer 18 in the form of carbon fiber tows. A bolt hole 16 is drilled into the composite structure and is arranged such that a mechanical fastener inserted in the hole 16 is in direct contact with the layer 18. This allows currents due to a lightning strike on or near the fastener to be conducted away from the fastener.

In FIG. 2, the reference numerals correspond to the same parts of FIG. 1. Isolators 20 in the form of cuts of the carbon fiber tows 18 are present to control the direction of conduction of currents away from the fastener to a desired location in the composite structure to a point via which the current can be removed from the structure following a lightning strike.

The composite structure of FIG. 2 may be formed by providing cuts into the reinforcement fiber tows. The cuts or discontinuities are introduced by laser cutting during the lay-up phase of the structure. Following lay-up as the resin cures, it flows into the gap and cures thereby forming a resilient insulative barrier to electrical charges and currents.

Several fibre discontinuites can be introduced per layer to either increase the efficacy of protection or to ensure that a safe zone is created which will accommodate tolerances in position of the discontinuities relative to the protected surface introduced through tolerances in manufacturing due to trimming and drilling operations.

The isolating discontinuities are several times the critical fiber length to ensure that the mechanical performance of the composite structure is not reduced.

The resin matrix as hereinbefore described may comprise any suitable resin including thermosets, thermoplastics or mixtures of the two. Preferably the resin is free from conductive ingredients which may accumulate in the fibre discontinuity and would reduce its isolating properties.

There is thus provided a structure and a method which enables effective control of electrical charges and/or currents in composite structures, particularly but not exclusively in composite aircraft or wind energy structures.

1. A composite structure comprising one or more electrically conductive pathways and one or more isolators for isolating the pathways from the bulk of the composite structure.

2. A composite structure according to claim 1 wherein the composite structure comprises fibre reinforcement and a reinforcement resin matrix, said electrically conductive pathways being formed from said fibre reinforcement and said reinforcement resin matrix.

3. A composite structure according to claim 2 wherein the electrically conductive pathways are formed from the same fibre reinforcement and the same resin matrix as the bulk of the composite structure.

4. A composite structure according to claim 1 wherein the electrically conductive pathways are discrete.

5. A composite structure according to claim 1 wherein the isolators are formed by an isolator resin matrix.

6. A composite structure according to claim 5 wherein the isolator resin matrix comprises the reinforcement resin matrix.

7. A composite structure according to claim 2 wherein the composite structure comprises multiple ply layers of fibre reinforcement, the isolator extending across at least two ply layers.

8. A composite structure according to claim 1 wherein the length of the isolator is n times the critical fibre length wherein n=1 to 10.

9. A composite structure according to claim 1 wherein the electrically conductive pathways are formed by unidirectional carbon fibre.

10. A composite structure according to claim 9, wherein the carbon fibre is coated with a metal.

11. A method of controlling current paths in a composite structure comprising providing one or more electrically conductive pathways in the structure and isolating the pathways from the bulk of the structure.

12. A method according to claim 11, wherein the electrically conductive pathway is isolated from the composite structure by means of isolators.

13. A method according to claim 11 wherein the composite structure is prepared from a lay-up of resin preimpregnated fibrous reinforcement material layers, the layers being arranged to connect metallic elements directly to the electrically conductive pathways of the structure.

14. A method according to claim 11 wherein one or more discontinuities are introduced in one or more layers to ensure that the electrically conductive pathway is isolated.

15. A method according to claim 11 wherein the composite structure has resin filled discontinuities or isolators.
